(19) United States
(12) Patent Application Publication
(10) Pub. No.: US 2026/0014462 A1
(43) Pub. Date: Jan. 15, 2026

(54) MULTIPLAYER SYSTEM AND METHOD

(71) Applicant: Sony Interactive Entertainment Inc., Tokyo (JP)

(72) Inventors: Maurizio Cerrato, London (GB); Lawrence Martin Green, London (GB); Jun Yen Leung, London (GB); Maria Chiara Monti, London (GB); Patrick John Connor, London (GB); Rajeev Gupta, London (GB)

(73) Assignee: Sony Interactive Entertainment Inc., Tokyo (JP)

(21) Appl. No.: 19/262,536

(22) Filed: Jul. 8, 2025

(30) Foreign Application Priority Data
Jul. 10, 2024 (GB) 2410040.6

(51) Int. Cl. A63F 13/493; A63F 13/847

(52) U.S. Cl. CPC A63F 13/493; A63F 13/847

(57) ABSTRACT

A method of operating a multiplayer game comprises the steps of, on a host device, running the multiplayer game configured as two separate processes, the first process being a gameplay logic application that manages progress of the game according to the game's rules; and the second process being a gameplay output application that manages the presentation of the game to a user at their device; wherein the gameplay logic application is operable to manage progress of the multiplayer game for a plurality of users, detecting if the gameplay output application stops normal operation whilst the gameplay logic application is managing progress of the multiplayer game for at least a predetermined number of other users of remote devices, and if so, continuing to operate the gameplay logic application despite the stopping of the other part of the same multiplayer game on the host device.

### FIELD OF THE INVENTION

The present invention relates to a multiplayer system and method.

### BACKGROUND

Traditionally, multiplayer games use a client-server model, where a central server (typically maintained by the games developer or publisher) coordinates the game-state of each instance of a game, receiving inputs from clients and transmitting game state updates back.

In some multiplayer games, such servers can be set up by individuals instead of or as well as by the developer or publisher—typically in this case a dedicated server tool is provided to allow such an individual to configure a computer to run as a server for this purpose. Often such tools are released once the game has become stable—that is, the balancing and behavior of the game at scale has been finalized, typically some time after the game's initial release.

However, both of these models have some problems. The first is that where server coordination is centralized, there can be capacity issues if the game proves to be very popular. The second is that where server coordination is made available as a tool for users, this can be unreliable as it requires enthusiasts to set up and maintain the servers, and could also invite security or compatibility problems if such citizen-servers are not updated as needed.

Embodiments of the present description seek to address or mitigate these problems.

### SUMMARY OF THE INVENTION

Various aspects and features of the present invention are defined in the appended claims and within the text of the accompanying description.

In a first aspect, a method of operating a multiplayer game is provided in accordance with claim 1.

In another aspect, an entertainment device is provided in accordance with claim 14.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the present description.

FIG. 2 is a flow diagram of a method of operating a multiplayer game in accordance with embodiments of the present description.

### DESCRIPTION OF THE EMBODIMENTS

A multiplayer system and method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

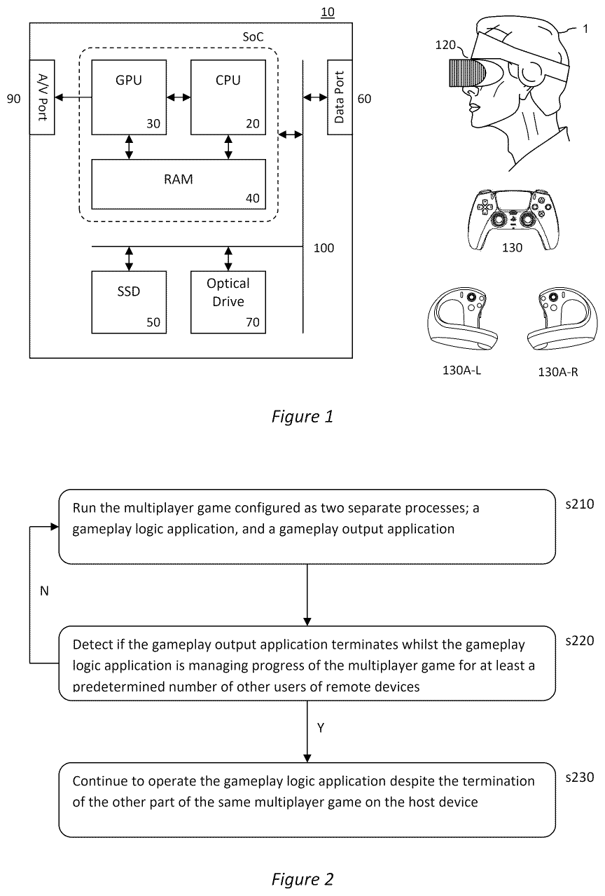

Referring now to the drawings, wherein like reference numerals designate identical or corresponding parts throughout the several views, FIG. 1 shows a computer or console operable for example as an entertainment system 10.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50.

The entertainment device may transmit or receive data via one or more data ports 60. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

An example of a device for displaying images output by the entertainment system is a head mounted display ‘HMD’ 120, worn by a user 1. Interaction with the system is typically provided using one or more handheld controllers 130, and/or one or more VR controllers (130A-L,R) in the case of the HMD.

As noted previously, multiplayer games can have problems with server centralization (whether by developers, publishers, or enthusiasts), resulting in capacity demands, maintenance costs, and the like.

One solution that can scale with the user base is a peer-to-peer system, where one of the players is the host and the other player(s) the connected clients. In this model, player clients that are not part of an existing group can broadcast their availability as a potential server for a group, and other clients can connect to it, forming client server peer groups on an ad-hoc basis.

However this approach has several drawbacks.

A notable one is that the code that handles the connections runs in the same context and environment as the game itself. This means that any crashing or lockup of the game on the host device will also stop the game for everyone else in the group.

Another is that the game is dependent on the player at the host device not choosing to quit the game and thus also stop hosting the group part way through (for example if they find themselves losing in the game).

A third is that the connection process is up to the developer, which can mean different and inconsistent techniques between games, compatibility problems if not all players update their games, management of issues such as whether necessary downloadable content has been installed, and finally whether the communications code is efficient and stable, particularly if part of that communication is routed through part of a third party network, such as one run by the manufacturers of the client device or the developers or publishers of the game.

Accordingly, in embodiments of the present description the operating system of the entertainment device, or equivalently a helper app thereof, implements a dual-process scheme configured to force the game to run in two parts as two separate processes, typically with separately allocated system resources.

The arrangement of the game play code to facilitate this may be enforced by a technical requirements checklist; in other words it is mandated that the game must be logically divided according to the scheme herein in order to be run as a peer multiplayer game on the entertainment device.

The mandated configuration is that a gameplay logic application (also referred to herein as the ‘daemon’) operates as a separate process to the game application (also referred to herein as the ‘game output application’) itself.

The gameplay logic application (the daemon) maintains a model of the game state so that it can determine e.g. one or more of player and non-player/object statistics and statuses, item collection, collision detection, the meeting of quest goals, and the like. In other words, it manages the progress/evolution of the game state according to the game's rules/logic and the user(s)' actions. The daemon may thus be thought of as the game engine (not to be confused with the game's graphics engine).

Subsequently the game output application communicates with the daemon using sockets, and sends the daemon the inputs of the user; the daemon then checks the inputs and communicates the result (enemy movements, collision detection, status changes and so on) back to the game application.

Notably, any non-gameplay-logic related elements of the game, such as a full or partial rendering pipeline, audio outputs, user camera movements, UI rendering, physics simulation etc., do not need to get a response from the daemon and are computed by the game output application as part of the process that is separate to that of the daemon.

Typically game code crashes, if they occur, do so in the rendering pipeline or when accessing memory pages or the like (e.g. due to pushing the hardware performance, or because the game is attempting to render or simulate something unanticipated, or where data has not been received completely in time, or the like). More generally, the game application is performing much more processing, on much more data, typically across both CPU, GPU, storage, and I/O and control ports, and so there is more scope for an error to occur.

Consequently, by moving the gameplay logic application into a separate process, the chances of this process also crashing or locking up if or when the rest of the game does so is greatly reduced.

Meanwhile the odds of the gameplay logic application itself crashing are typically very small because it does not interact with such higher risk functionality. Furthermore, if it does crash, rebooting it alone can be quick because it is typically a small application with few data assets or dependencies, and so the game can be recovered quickly.

In this way, the architecture of the game is configured into separate components; these components separately provide game logic and game output functionality. This can also be thought of as server and client functionality, particularly if the component providing game logic does so form multiple players. It will be appreciated that this architecture also applies potentially even if the game is not currently hosting other players and is operating in a solo mode (in effect, operating as a client/server multiplayer game for one player, possibly also for a single-player mode of the game).

As noted the two halves of the game communicate with each other for example via sockets, where a socket is a two-way communication channel determined by a specific IP address (e.g., loopback address 127.0. 0.1 which can be used by a computer to refer to itself) and a port (e.g., 8080) on a computer. The remote client devices of other players can also communicate via sockets with the host entertainment device over a network such as the internet, or a LAN.

Alternatively or in addition the game output application on the same host entertainment device as the game logical application may optionally communicate via an API or any suitable arms-length communication, where one application leaves data for the other to access independently. Optionally the input from the game application on the same device may then the presented to the game logic application, or parsed by the game logic application, as if received via a socket, so that all inputs and outputs for the game logic application are of a similar type. Such an alternative approach may be used, for example, when only the local player is playing so that the socket/communication port is not used when not needed.

In any event, the game logic application can manage a game state, receive inputs from one or more game applications, and generate output for them, via one or more sockets (and optionally an alternative or additional arms-length communications such as an API for the instance of the game application on the same host entertainment device as the game logic application).

In this way, the game logic application can coordinate a multiplayer game independently of the local instance of the game application playing on the host device.

As a result, advantageously if the local instance of the game application crashes, locks up, or pauses, the game logic application can continue to coordinate the multiplayer game. Similarly is the player on the host entertainment device quits the game application, the game logic application can continue as a separate background process to serve the other players, at least for the current game session.

Hence this provides much greater stability for players when using a peer-to-peer scheme, both because it is independent of intentional or unintentional stoppage of the game application, and because the communication process between client and host is unified for any game using the techniques herein, and so the communications and networking can be optimized for that approach.

To improve the stability for all players, the dual-process scheme can implement some further rules.

As suggestion previously herein, even if the user of the host device quits the game, or the game output application crashes, the daemon can continue coordinating a multiplayer game, at least for a current game session, if there are at least a predetermined number of other clients still linked to the daemon for that session. For example, if there are two or more other clients (and hence still multiple players) or optionally for one other client e.g. for a limited period (e.g. between 1 and 5 minutes), in case the host re-starts the game, or another player is able to join it.

If there are no other clients, or all the other clients disconnect (or optionally once only one other client is connected), the daemon can quit as well to free up system resources. Hence it will be appreciated that if the user of the host device is playing solo, the daemon will start-up and close along with the game application.

Similarly, if the game is quit or crashes, but is restarted while the daemon from a previous run is still operating, the game application, or a launcher app associated with it, checks to see if the daemon is already running and if so does not start a new instance of the daemon, but instead joins the game application to the session being run by the daemon (or queues the game application to join at the next opportunity in-game).

Optionally the user of the host can override these rules to either close the daemon when the quit the game, or reset or re-load the daemon when they re-start the game.

Meanwhile for client devices, these are essentially the same as the host device (as is typically the case in peer-to-peer networks, where the devices, at least for the intended purpose, are essentially the same or compatible with each other). Hence in this case they also have the game output application and the game logic application available as separate processes as well—but as clients they do not necessarily need the game logic application as this functionality is being handled by the host.

Hence when a client device becomes a client in such a multiplayer game, the game logic application on that client device can optionally not be started, or shut down or be idle (depending on at what stage the role of client is determined).

In some embodiments, optionally the game logic application in the client can have the role of receiving the information from the game logic application of the host, and passing it locally to the game application on the same client device (and similarly receiving updates from the client game application to send back to the host daemon)—in this way the game application only ever needs to communicate with its local instance of the daemon, whether acting as host or client, simplifying the communications of the game output application.

This can also help stability if the game application of a client device crashes or pauses—the client daemon on the separate process can still maintain communications with host daemon and perhaps signal a hiatus for the client whilst the game output application is restarted, enabling the user to gracefully re-join the same game instance.

When a user wants to play the multiplayer game, a user interface may invite them to run the game in host/server mode or in client mode, letting the user decide.

However, potentially more efficient is that when a player tries to initiate a multiplayer game, the game suggests ‘waiting for players’ or similar, and a set of entertainment devices are identified that are for example geographically close, or meet some other criteria such a for example membership of a ‘clan’ or being on reciprocal friend lists, or the like, and/or relative ping times to each other or to a local server.

The identification may be done by peer-to-peer polling by the entertainment device or by coordination with a server (for example a server that all the entertainment devices can access for general networking or matchmaking purposes). Hence as a non-limiting example, a set of entertainment devices with users having the same default language, two friends in the set, and ping times to each other of <200 ms, may be identified as a group.

Once sufficient devices for a multiplayer session are identified is such a manner, the actual host device that will run the host daemon may be decided upon based on one or more criteria. These criteria may include: upload data speed, download data speed, and ping (e.g. average ping over all peers, optionally ignoring fastest and/or slowest, or any other suitable ping assessment scheme). Where the entertainment devices are not all identical, the criteria may optionally include one or more of memory capacity and processing capacity. Optionally entertainment devices or games could keep a local crash count as a criterion, to indicate that device's apparent stability for the game. Where two or more of these criteria are used to evaluate the peers, their contribution to an overall suitability score may be weighted for example according to empirically determined weightings.

In this way, the peer entertainment device that appears to be the best suited to be the host according to the chosen criteria may be selected for the role-optionally even if this is not the entertainment device of a user that initiated the multiplayer session.

The above techniques advantageously provide a more stable peer-to-peer based client-server multiplayer game system, which scales with the user base to address issues that occur with centralized server loads in conventional client-server systems.

However, this is still not immune to interruption; if the user of the host entertainment device experiences a game crash, or quits the game, it is relatively likely that they will shortly thereafter turn the entertainment device off, or possibly choose to run another game or application that requires the resources currently allocated to the host daemon. In these circumstances, the multiplayer game would still be disrupted.

Accordingly, in embodiments of the present description, the host daemon provides one or more client daemons with the state of the game logic, with the intention of these being back-up daemons in the event that it is closed.

The host daemon may for example provide the full information periodically and then updates or deltas in an ongoing fashion. Hence for example the host daemon may provide the full information every 1 or 5 seconds, and/or when there is relatively little other information being shared, and then provide deltas e.g. every frame. Notably, each of the client devices already receive game state updates (deltas) each frame (or on a similar periodicity) to display the evolving came to their user, although these may be limited to a game state local to that user in-game; the full game state delta is thus an aggregate or union of these existing updates sent to one or more daemons. Optionally further delta information relating to game state updates independent of any player (e.g. unseen non-player character behavior, or the like) are also provided if necessary.

Subsequently, if the current host is shut down, typically the operating system of the host device is shut down in a managed and graceful process and so the host daemon can nominate the next host from the one or more backup daemons, and inform it and the other clients of the switch as part of its shutdown process. In this case, other players should notice no change in the multiplayer session at all, except perhaps the departure of the host user (if they had not already quit).

In the rare event that a current host daemon became inaccessible without warning (e.g. due to a power cut, or a crash of a home router independent of the operation of the entertainment device), the or each backup daemons would recognize the loss of updates and one would assume control, informing the other clients. In this case, the game may in effect pause momentarily on the last distributed game state before resuming, typically after only a fraction of a second.

The selection of one or more backup daemons, and in the case of plural backups which should assume control, can be based on the same determination that shoes the original host; hence for example the next two best client devices could be chosen as backups, with the immediately next best being the default to take over, with this process repeated if successive host devices become unavailable.

This last scenario may be more likely in the case of so-called persistent world games; some such games may last persistently for months or years, some for only hours.

In the context of the present techniques, a world could persist for as long as there is at least one player of the game active; as players come and go, the state of the game logic application is passed along.

This may be adequate for worlds that can persist for a few hours (e.g. for a specific campaign) but would not be suitable for games that last for days, weeks, or months, where there is the combined risk of there being a time where no players are active, and potentially also that a greater investment in the state of the game world would be lost as a result.

Accordingly, in embodiments of the present invention, a server (e.g. a server run by the developer, publisher, and/or entertainment device manufacturer) can run an instance of the game logic application (daemon) and act as a backup daemon for groups of players, whilst being an invisible non-participant in the game itself. In this case, potentially all the players could quit and the game state would be preserved by the server. The players may then opt to revisit the game state later, and the daemon may migrate back to the best host in the peer group for the duration of play.

It will be appreciated that such a server-based daemon may be deployed for any group, whether the game is persistent or not, to act as the backup daemon, at least temporarily, in the case that a host daemon closes.

It will be appreciated that acting as a backup daemon requires far fewer resources than either running the full game or even running as the host daemon; as a result this centralized protection of the scheme is still relatively more scalable than a conventional centralized client-server scheme.

Optionally the server may only act as a back-up daemon if the number of active players drops below a critical number (e.g. fewer than the normal number of host and back-up daemons in a multiplayer group), perhaps indicating that the group are in the process of exiting a session, or if the would-be next available client daemon in the multiplayer group does not meet a criterion for being a backup daemon, such as ping time or upload speed. This reduces the centralized overhead on the server(s) even more.

The server side backup daemon could then go idle or be saved to storage, and only spun back up again if users re-join that session. Optionally the daemon could be deleted or repurposed if no users re-join after a specified period or if some form of session retention scheme (such as a subscription) ends.

Referring now also to FIG. 2, in a summary embodiment of the present description, a method of operating a multiplayer game (e.g. in a peer-to-peer configuration) comprises the following steps.

On a host device (such as entertainment device 10), in a first step s210 running the multiplayer game configured as two separate processes, the first process being a gameplay logic application that manages progress of the game according to the game's rules; and the second process being a gameplay output application that manages the presentation of the game to a user at their device, as described elsewhere herein.

The gameplay logic application is operable to manage progress of the multiplayer game for a plurality of users, as described elsewhere herein, although as also described elsewhere herein, it can operate in a similar manner for solo play of the game (e.g. either multiplayer just for the host device's user, or for a solo-play mode of the game other than the multiplayer game, for the host device's user).

In a second step s220, detecting (for example by the OS, a helper app, or the host gameplay logic application, or a combination of two or more of these) if the gameplay output application terminates whilst the gameplay logic application is managing progress of the multiplayer game for at least a predetermined number of other users of remote devices, as described elsewhere herein.

If so detected, then at a third step s230, continuing to operate the gameplay logic application despite the termination of the other part of the same multiplayer game on the host device, as described elsewhere herein.

With this the method, a group of devices can play a multiplayer game in a more reliable and robust manner, as described elsewhere herein.

It will be apparent to a person skilled in the art that variations in the above method corresponding to operation of the various embodiments of the apparatus as described and claimed herein are considered within the scope of the present invention, including but not limited to that: the gameplay logic application and the gameplay output application have access to separate respective system resources (e.g. one or more of processors, processor threads, working memory, shaders for computation, AI resources, storage, and the like), as described elsewhere herein;
the gameplay logic application of the host device communicates with one or more gameplay output applications (optionally including the one on the same device) or other gameplay logic applications (e.g. of remote devices) via sockets, as described elsewhere herein;
a gameplay output application communicates with its respective corresponding instance of the gameplay logic application, which communicates with the host gameplay logic application via sockets (which simplifies the communications between the two parts of the game so that they are substantially the same whether operating as host or client), as described elsewhere herein;
if the gameplay output application of the host device terminates whilst the gameplay logic application of the host device is managing progress of the multiplayer game for at least a predetermined number of other users of remote devices, and if the gameplay output application of the host device is restarted, then the method comprises detecting if the gameplay logic application is already running, and if so not starting a new instance of the gameplay logic application or resetting the already running gameplay logic application, as described elsewhere herein;
the gameplay logic application of the host device providing data to a gameplay logic application of at least a first user's remote device in an ongoing manner that would enable the gameplay logic application of that remote device to operate as the host gameplay logic application in the event that the gameplay logic application of the host device became unable to continue as the host gameplay logic application, as described elsewhere herein; remote devices participating the in the multiplayer game similarly run the gameplay output application, and run the gameplay logic application to receive progress updates from the host gameplay logic application, and the method comprises the steps of if the gameplay output application of a remote device terminates, the corresponding gameplay logic application continues to operate subject to at least a first predetermined criterion, and if the gameplay output application of the remote device is restarted, then detecting if the gameplay logic application of the remote device is already running, and if so, not starting a new instance of the gameplay logic application or resetting the already running gameplay logic application, thereby re-joining the existing multiplayer game, as described elsewhere herein;
for a plurality of devices each having the multiplayer game, selecting one of the devices to act as the host based upon one or more criteria (e.g. ping time, upload speed, or comparative hardware and/or software performance or generation); and the selected device causing its instance of the gameplay logic application to act as the host gameplay logic application, as described elsewhere herein;
for a plurality of devices each having the multiplayer game, selecting one or more of the devices to act as a back-up host based upon one or more criteria (e.g. again ping time, upload speed, or comparative hardware and/or software performance or generation); and the selected or each device causing its instance of the gameplay logic application to act as a back-up host gameplay logic application, as described elsewhere herein;
the method comprises the steps of a server joining the multiplayer game and running a gameplay logic application without running an equivalent gameplay output application, thereby acting as a non-participatory member of the multiplayer game, and the gameplay logic application of the server is operable to act as a backup-up host gameplay logic application, as described elsewhere herein;
in this instance, optionally the backup-up host gameplay logic application of the server preserving the state of the multiplayer game in the event that fewer than a predetermined number of users remain active in the multiplayer game, as described elsewhere herein; and in this instance in turn, optionally the backup-up host gameplay logic application of the server preserves the state of the multiplayer game subject to at least a first retention criterion being met, as described elsewhere herein.

As noted elsewhere herein, the term ‘terminates’ as used herein may encompass intentional termination (e.g. when a user chooses to quit the game), and unintentional termination (e.g. due to a crash, freeze, or other failure). Hence more generally, ‘terminates’ may be understood as ‘stopping normal operation’ for the purposes of the functionality described herein, typically independent of specific cause.

It will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, referring again to FIG. 1, in a summary embodiment of the present description an entertainment device (e.g. entertainment device 10), configured to operate a multiplayer game, comprises the following:

At least a first processor (e.g. CPU 20, GPU 30, or a combination thereof) configured in operation (for example by suitable software instruction) to provide an operating system arranged to run the multiplayer game configured as two separate processes, the first process being a gameplay logic application that manages progress of the game according to the game's rules; and the second process being a gameplay output application that manages the presentation of the game to a user at their device, as described elsewhere herein.

The gameplay logic application is operable to manage progress of the multiplayer game for a plurality of users, as described elsewhere herein.

If the gameplay output application terminates whilst the gameplay logic application is managing progress of the multiplayer game for at least a predetermined number of other users of remote devices, as a host gameplay logic application (the termination being detected for example by the operating system, a helper app, the game play logic application, or optionally the gameplay output application itself in the case of a deliberate, managed termination), as described elsewhere herein, then the operating system (e.g. the OS or a helper app therefor) is arranged to continue operation of the host gameplay logic application despite the termination of the other part of the same multiplayer game on the host device, as described elsewhere herein.

Instances of this summary embodiment implementing the methods and techniques described herein (for example by use of suitable software instruction) are envisaged within the scope of the application, including but not limited to that:
the host gameplay logic application is configured (for example by suitable software instruction to provide data (for example via data port 60) to a gameplay logic application of at least a first user's remote device in an ongoing manner (e.g. periodically and/or with deltas) that would enable the gameplay logic application of that remote device to operate as the host gameplay logic application in the event that the gameplay logic application of the host device became unable to continue as the host gameplay logic application, as described elsewhere herein.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method comprising:
running, on a host device, a multiplayer game configured as two separate processes including a first process and a second process,
the first process including a gameplay logic application that manages progress of the multiplayer game according to rules of the multiplayer game and is operable to manage progress of the multiplayer game for a remote user device, and
the second process including a gameplay output application that manages a presentation of the multiplayer game by the host device;
detecting, by the host device, the gameplay output application stops a normal operation while the gameplay logic application is operating as a host gameplay logic application that manages progress of the multiplayer game for the remote user device; and
after detecting the stopping, continuing operation of the gameplay logic application.

2. The method of claim 1, wherein the gameplay logic application and the gameplay output application have access to separate respective system resources.

3. The method of claim 1, wherein the gameplay logic application communicates with one or more other gameplay output applications including a second gameplay output application or one or more other gameplay logic applications including a second gameplay logic application via sockets.

4. The method of claim 3, wherein the second gameplay output application communicates with the second gameplay logic application via sockets.

5. The method of claim 1, further comprising responsive to determining the gameplay output application is restarted:
detecting if the gameplay logic application is already running, and if so, refraining from starting a new instance of the gameplay logic application or resetting the gameplay logic application that is already running.

6. The method of claim 1, further comprising: providing, by the gameplay logic application, data to a second gameplay logic application of at least a remote device in an ongoing manner that enables the second gameplay logic application to operate in place of the gameplay logic application in the in an event that the gameplay logic application became unable to operate.

7. The method of claim 1, wherein a remote device participating in the multiplayer game runs a second gameplay output application, and runs a second gameplay logic application to receive progress updates from the second gameplay logic application, the method further comprising:
responsive to the second gameplay output application of the remote device stopping the normal operation, the second gameplay logic application continues to operate subject to at least a first predetermined criterion, and
responsive to the second gameplay output application of the remote device being restarted:
detecting the second gameplay logic application of the remote device is already running; and
refraining from starting a new instance of the second gameplay logic application or resetting the already running second gameplay logic application, thereby re-joining the multiplayer game.

8. The method of claim 1, further comprising:
for a plurality of devices each having the multiplayer game, selecting one of the devices to act as a host, instead of the host device, based upon one or more criteria; and
the selected device causing its instance of the gameplay logic application to act as the gameplay logic application for the plurality of devices.

9. The method of claim 1, further comprising:
for a plurality of devices each having the multiplayer game, selecting one or more of the devices to act as a back-up host device based upon one or more criteria; and
the selected one or more devices causing their instances of the gameplay logic application to act as a back-up host gameplay logic application.

10. The method of claim 1, further comprising:
joining, by a server, the multiplayer game and running a second gameplay logic application without running a corresponding second gameplay output application, thereby acting as a non-participatory member of the multiplayer game, wherein the second gameplay logic application of the server is operable to act as a backup-up host gameplay logic application in place of the gameplay logic application.

11. The method of claim 10, further comprising:
preserving, by the backup-up host gameplay logic application of the server, a state of the multiplayer game when fewer than a predetermined number of users remain active in the multiplayer game.

12. The method of claim 11, wherein the backup-up host gameplay logic application of the server preserves the state of the multiplayer game subject to at least a first retention criterion being met.

13. (canceled)

14. (canceled)

15. (canceled)

16. One or more non-transitory computer-readable storage media storing instructions that, upon execution by one or more processors of a host device, cause the host device to perform operations comprising:
running, on the host device, a multiplayer game configured as two separate processes including a first process and a second process,
the first process including a gameplay logic application that manages progress of the multiplayer game according to rules of the multiplayer game and is operable to manage progress of the multiplayer game for a remote user device, and
the second process including a gameplay output application that manages a presentation of the multiplayer game by the host device;
detecting, by the host device, the gameplay output application stopping normal operation while the gameplay logic application is operating as a host gameplay logic application that manages progress of the multiplayer game for the remote user device; and
after detecting the stopping, continuing operation of the gameplay logic application.

17. The non-transitory computer-readable storage media of claim 16, wherein the instructions further cause the one or more processors to perform operations further comprising:
communicating, by the gameplay logic application, with a second gameplay output application or a second gameplay logic application via sockets.

18. The non-transitory computer-readable storage media of claim 16, wherein the instructions further cause the one or more processors to perform operations further comprising:
responsive to determining the gameplay output application is restarted:
detecting the gameplay logic application is already running; and
refraining from starting a new instance of the gameplay logic application or resetting the gameplay logic application that is already running.

19. The non-transitory computer-readable storage media of claim 16, wherein the instructions further cause the one or more processors to perform operations further comprising:
providing, by the gameplay logic application, data to a second gameplay logic application of at least a first remote user device to cause the second gameplay logic application of the first remote user device to operate as the host gameplay logic application in an event that the gameplay logic application of the host device became unable to continue as the host gameplay logic application.

20. A host device comprising:
one or more storage media storing instructions; and
one or more processors configured to execute the instructions to cause the host device to:
run a multiplayer game including a first process and a second process,
the first process including a gameplay logic application that manages progress of the multiplayer game according to rules of the multiplayer game and manages progress of the multiplayer game for a remote user device, and
the second process being a gameplay output application that manages a presentation of the multiplayer game by the host device;
detecting, by the host device, the gameplay output application stops a normal operation while the gameplay logic application is operating as a host gameplay logic application that manages progress of the multiplayer game for the remote user device; and
after detecting the stopping, continuing operation of the gameplay logic application.

21. The host device of claim 20, wherein the instructions further cause the one or more processors to cause the host device to perform operations further comprising:
communicating, by the gameplay logic application, with a second gameplay output application or a second gameplay logic application via sockets.

22. The host device of claim 20, wherein the instructions further cause the one or more processors to cause the host device to perform operations further comprising:
responsive to determining the gameplay output application is restarted:
detecting the gameplay logic application is already running; and
refraining from starting a new instance of the gameplay logic application or resetting the gameplay logic application that is already running.

23. The host device of claim 20, wherein the instructions further cause the one or more processors to cause the host device to perform operations further comprising:
providing, by the gameplay logic application, data to a second gameplay logic application of at least a first remote user device to cause the second gameplay logic application of the first remote user device to operate as the host gameplay logic application in an event that the gameplay logic application of the host device became unable to continue as the host gameplay logic application.
